(19) United States
(12) Patent Application Publication
(10) Pub. No.: US 2026/0022802 A1
(43) Pub. Date: Jan. 22, 2026

(54) HYDROGEN SUPPLY SYSTEM

(71) Applicant: TOYOTA JIDOSHA KABUSHIKI KAISHA, Toyota-shi (JP)

(72) Inventors: Naoki TOMI, Kawasaki-shi (JP); Yoshikatsu FUJIMURA, Toyota-shi (JP); Tetsuya TONOSAKO, Fuji-chi (JP)

(73) Assignee: TOYOTA JIDOSHA KABUSHIKI KAISHA, Toyota-shi (JP)

(21) Appl. No.: 19/182,855

(22) Filed: Apr. 18, 2025

(30) Foreign Application Priority Data
Jul. 19, 2024 (JP) 2024-115469

(51) Int. Cl. F17C 7/00; F23K 5/00; H01M 8/04082; H01M 8/04089; H01M 8/0432; H01M 8/04746

(52) U.S. Cl. CPC F17C 7/00; F23K 5/007; H01M 8/04089; H01M 8/04201; H01M 8/04373; H01M 8/04753; F17C 2205/0323; F17C 2205/037; F17C 2221/012; F17C 2250/03; F17C 2250/043; F17C 2250/0439; F17C 2265/06; F17C 2270/0105; F17C 2270/0173; F17C 2270/0178; F17C 2270/0184; F17C 2270/0189; F23K 2900/05002

(57) ABSTRACT

A hydrogen supply system including: a plurality of hydrogen tanks that is attachable and detachable; a hydrogen consumption device that consumes hydrogen of the hydrogen tanks; and a control device is provided. The hydrogen consumption device includes an attaching-detaching mechanism including a plurality of motors that controls attaching and detaching of the hydrogen tanks with respect to the hydrogen consumption device, the motors corresponding to the attaching and detaching of the respective hydrogen tanks. The control device disposes, based on a temperature of each of the motors, a hydrogen tank of the hydrogen tanks to a hydrogen supply start position at which the hydrogen tank and the hydrogen consumption device are connected in a state in which the hydrogen tank is allowed to supply hydrogen to the hydrogen consumption device, or disposes the hydrogen tank to a hydrogen supply standby position.

### CROSS-REFERENCE TO RELATED APPLICATION

This application claims priority to Japanese Patent Application No. 2024-115469 filed on Jul. 19, 2024. The disclosure of the above-identified application, including the specification, drawings, and claims, is incorporated by reference herein in its entirety.

### BACKGROUND

### 1. Technical Field

The present disclosure relates to a hydrogen supply system.

### 2. Description of Related Art

Japanese Unexamined Patent Application Publication No. 2023-056947 (JP 2023-056947 A) discloses a moving body having attachable and detachable hydrogen tanks mounted thereon.

### SUMMARY

In a hydrogen supply system, a hydrogen tank is moved to a hydrogen supply start position or a hydrogen supply standby position by control of a motor for attachment or detachment of the hydrogen tank, but, during operation of a hydrogen consumption device, in order to maintain connection to a hydrogen pipe of the hydrogen tank, the motor is required to continuously output certain torque against an inner pressure of the hydrogen tank and a spring force. Accordingly, when the hydrogen consumption device is continuously operated, there arises a problem of increase in temperature of the motor.

The present disclosure has been made in view of the above-mentioned circumstance, and has a primary object to provide a hydrogen supply system capable of reducing rise of a temperature of a motor at the time of continuous operation of a hydrogen consumption device.

That is, the present disclosure includes the following aspects.
<1> A first aspect of the disclosure relates to a hydrogen supply system including: a plurality of hydrogen tanks that is attachable and detachable; a hydrogen consumption device that consumes hydrogen of the hydrogen tanks; and a control device.

The hydrogen consumption device includes an attaching-detaching mechanism including a plurality of motors that controls attaching and detaching of the hydrogen tanks with respect to the hydrogen consumption device, the motors corresponding to the attaching and detaching of the respective hydrogen tanks.

The control device disposes, based on a temperature of each of the motors, a hydrogen tank of the hydrogen tanks to a hydrogen supply start position at which the hydrogen tank and the hydrogen consumption device are connected in a state in which the hydrogen tank is allowed to supply hydrogen to the hydrogen consumption device, or disposes the hydrogen tank to a hydrogen supply standby position at which the hydrogen tank and the hydrogen consumption device are not connected in the state in which the hydrogen tank is allowed to supply the hydrogen to the hydrogen consumption device and the hydrogen tank stands by for supply of the hydrogen.
<2> In the hydrogen supply system according to <1>, when the hydrogen tanks are disposed at the hydrogen supply start position:
the control device may determine whether or not the temperature of each of the motors is equal to or higher than a first threshold value; and
when the temperature of at least one motor out of the motors is equal to or higher than the first threshold value, the control device may move at least a hydrogen tank that is controlled in the attaching and detaching by a motor having the highest temperature from the hydrogen supply start position to the hydrogen supply standby position, and may stop control of the motor having the highest temperature.
<3> In the hydrogen supply system according to <2>, the control device may determine whether or not the temperature of the stopped motor is equal to or lower than a second threshold value.

When the temperature of the stopped motor is equal to or lower than the second threshold value, the control device may start control of the stopped motor, and may move the hydrogen tank that is controlled in the attaching and detaching by the motor for which the control has been started from the hydrogen supply standby position to the hydrogen supply start position.
<4> In the hydrogen supply system according to any one of <1>to <3>, the hydrogen tank may include a first connection portion.

The attaching-detaching mechanism may include an attaching-detaching unit. The attaching-detaching unit may include a second connection portion.

At the hydrogen supply start position, the first connection portion of the hydrogen tank and the second connection portion of the attaching-detaching unit may be connected.

At the hydrogen supply standby position, the first connection portion of the hydrogen tank and the second connection portion of the attaching-detaching unit may not be connected.
<5> In the hydrogen supply system according to <4>, the first connection portion may be an on-off valve.

The second connection portion may be a push rod.

The hydrogen supply system of the present disclosure can reduce the rise of the temperature of the motor at the time of the continuous operation of the hydrogen consumption device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an example of a configuration of a hydrogen supply system of the present disclosure;

FIG. 2 is a schematic view illustrating an example of a state in which a hydrogen tank is disposed at a hydrogen supply standby position W;

FIG. 3 is a schematic view illustrating an example of a state in which the hydrogen tank is disposed at a hydrogen supply start position S;

FIG. 4 is a flowchart illustrating an example of connection control of hydrogen tanks;

FIG. 5 is a view illustrating an example of a time chart in a case where normal operation is carried out in STEP 4 in the connection control of the hydrogen tanks illustrated in FIG. 4; and

FIG. 6 is a view illustrating an example of a time chart in a case where restriction operation is carried out in STEP 4 in the connection control of the hydrogen tanks illustrated in FIG. 4.

### DETAILED DESCRIPTION OF EMBODIMENTS

The present disclosure provides a hydrogen supply system including: a plurality of hydrogen tanks that is attachable and detachable; a hydrogen consumption device that consumes hydrogen of the hydrogen tanks; and a control device. The hydrogen consumption device includes an attaching-detaching mechanism including a plurality of motors that controls attaching and detaching of the hydrogen tanks with respect to the hydrogen consumption device, the motors corresponding to the attaching and detaching of the respective hydrogen tanks. The control device disposes, based on a temperature of each of the motors, a hydrogen tank of the hydrogen tanks to a hydrogen supply start position at which the hydrogen tank and the hydrogen consumption device are connected in a state in which the hydrogen tank is allowed to supply hydrogen to the hydrogen consumption device, or disposes the hydrogen tank to a hydrogen supply standby position at which the hydrogen tank and the hydrogen consumption device are not connected in the state in which the hydrogen tank is allowed to supply the hydrogen to the hydrogen consumption device and the hydrogen tank stands by for supply of the hydrogen.

The hydrogen supply system of the present disclosure includes a plurality of hydrogen tanks that is attachable and detachable, a hydrogen consumption device that consumes hydrogen of the hydrogen tanks, and a control device.

The hydrogen supply system of the present disclosure may be used in a moving body such as a vehicle, a railway vehicle, a ship, or an aircraft, or a stationary power generation system such as a fuel cell power generator. Examples of the vehicle include a fuel cell electric vehicle and a hydrogen engine vehicle.

### Hydrogen Tank

The hydrogen tank (hereinafter sometimes referred to as “tank”) is a container that stores hydrogen, and hydrogen is supplied from the hydrogen tank to the hydrogen consumption device. The hydrogen supply system includes a plurality of (n) hydrogen tanks. It is sufficient that n is an integer of 2 or more, and particularly has no upper limit.

It is sufficient that the hydrogen tank has an attachable and detachable configuration, and a publicly-known configuration that can be used as the hydrogen tank is applicable.

The hydrogen tank includes a hydrogen tank main body that is a part that stores the hydrogen, and a hydrogen supply port that is an inlet or outlet of the hydrogen of the hydrogen tank main body.

The hydrogen tank may include a first connection portion (a connection portion on the hydrogen tank side) to be connected to the hydrogen consumption device. The first connection portion includes the hydrogen supply port.

The first connection portion may be an on-off valve (that is sometimes referred to as “tank shut valve”) or the like.

The on-off valve may include a valve body and the hydrogen supply port.

The valve body is a valve that switches permission and restriction of communication between inside and outside of the hydrogen tank. The valve body is biased so as to restrict the communication when the valve is closed, and the communication is permitted when the valve body is moved by pressing the valve body against a biasing force. In order to permit and restrict the communication by pressing the valve body and canceling the pressing, the hydrogen consumption device may include a push rod as means for pressing the valve body.

The push rod is to be inserted to the hydrogen supply port.

The hydrogen tank may be provided with a handle to be grasped when the hydrogen tank is attached to or detached from the hydrogen consumption device.

### Hydrogen Consumption Device

The hydrogen consumption device is a device that is a hydrogen supply destination of the hydrogen tank. The hydrogen consumption device receives the hydrogen and consumes the received hydrogen.

The hydrogen consumption device includes an attaching-detaching mechanism that attaches and detaches the hydrogen tank with respect to the hydrogen consumption device.

The attaching-detaching mechanism includes a motor. The motor controls attaching and detaching of the hydrogen tank with respect to the hydrogen consumption device. The hydrogen consumption device includes a plurality of (n) motors corresponding to the attaching and detaching of the respective plurality of (n) hydrogen tanks.

The motor may directly transmit a drive force of the motor to the hydrogen tank, or may transmit the drive force of the motor to a movable portion of an attaching-detaching unit.

The motor may be a stepping motor.

The stepping motor is a motive power source that moves the movable portion via a gear. The specific aspect of the stepping motor is not particularly limited, and a publicly-known stepping motor can be used.

The stepping motor is electrically connected to the control device, and a rotation angle and a rotation speed are controlled based on a signal from the control device. In this manner, the movement of the movable portion is accurately controlled.

The stepping motor may include a sensor such as a position sensor, a motor torque sensor, or a motor temperature sensor.

The position sensor detects the position of the hydrogen tank, in particular, the position of the on-off valve. The position sensor may detect the position of the on-off valve based on the rotation angle of the stepping motor detected by the motor torque sensor, or may sense the position of the on-off valve based on the temperature of the stepping motor detected by the motor temperature sensor.

The specific aspect of the sensor is not particularly limited, and a publicly-known sensor can be used. The sensor is electrically connected to the control device, and is configured to be capable of transmitting a signal indicating the measured position of the hydrogen tank to the control device.

The attaching-detaching mechanism may include a hydrogen tank biasing mechanism.

The hydrogen tank biasing mechanism means a mechanism having a biasing force for moving, in a free state not affected by other external forces, the hydrogen tank from a position (a hydrogen supply start position) at which the first connection portion of the hydrogen tank is connected to a second connection portion of the hydrogen consumption device to a predetermined position (a hydrogen supply standby position) in a direction in which the first connection portion of the hydrogen tank is separated from the second connection portion of the hydrogen consumption device.

The hydrogen tank biasing mechanism may be a mechanism that directly transmits the biasing force of the biasing mechanism to the hydrogen tank, or may be a spring or the like. The hydrogen tank biasing mechanism may be a configuration in which a spring is attached to the hydrogen tank, or a configuration in which a spring is attached to the movable portion.

The attaching-detaching mechanism may include an attaching-detaching unit (attaching portion) that allows the hydrogen tank to be attached or detached.

The attaching-detaching unit may include a fitting portion and the movable portion.

The fitting portion is to be fitted to the hydrogen tank. It is sufficient that the fitting portion is fitted to at least an end portion of the hydrogen tank on the hydrogen supply port side in a state in which the hydrogen tank is attached to the attaching-detaching unit. The fitting portion may be fitted to the entire hydrogen tank, or may be fitted to also an end portion of the movable portion on a side facing the fitting portion.

At the time of fitting the hydrogen tank to the fitting portion, the first connection portion of the hydrogen tank and the second connection portion of the fitting portion are connected.

The hydrogen consumption device may include the second connection portion (a connection portion on the hydrogen consumption device side).

The second connection portion is a portion to be connected to the first connection portion of the hydrogen tank and forming a flow path (communication) to the hydrogen tank. The second connection portion may be provided on the fitting portion of the attaching-detaching unit. The second connection portion may be a push rod or the like.

The push rod is a member capable of pressing the valve body included in the on-off valve of the hydrogen tank. The push rod may have a bar shape, and may press the valve body at its distal end. The push rod may be configured to be insertable to the hydrogen supply port of the on-off valve.

Further, the push rod may be configured to form, when the push rod presses the valve body to bring the on-off valve to an open state, a flow path so that the hydrogen flows to a supply flow path from the inside of the hydrogen tank.

The attaching-detaching mechanism may include a lock portion that latches (locks) the hydrogen tank at a predetermined position when the movement of the hydrogen tank is restricted.

The predetermined position may be the hydrogen supply start position, or may be the hydrogen supply standby position.

The lock portion latches the hydrogen tank at the predetermined position in lock control to achieve a lock state of restricting the movement of the hydrogen tank, and cancels the latching in unlock control to bring the hydrogen tank to an unlock state of permitting the movement of the hydrogen tank.

The lock portion is electrically connected to the control device, and the control device drives the lock portion based on an input signal to switch the lock portion between the lock state of restricting the movement of the hydrogen tank and the unlock state of permitting the movement of the hydrogen tank.

The lock portion may be a lock pin or the like.

The lock pin may be disposed on the fitting portion.

The lock pin is a pin disposed to be projectable to and retractable from an engagement recessed portion of the movable portion. At the time of projection, the lock pin can enter the inner side of the engagement recessed portion to be engaged with the engagement recessed portion. Meanwhile, at the time of retraction, the lock pin is disposed so as not to be engaged with the engagement recessed portion.

The lock pin is electrically connected to the control device, and the projection and the retraction of the lock pin are controlled based on a signal from the control device.

The movable portion moves the hydrogen tank through the control of the motor. The movable portion moves in directions in which the first connection portion of the hydrogen tank approaches and separates away from the second connection portion of the hydrogen consumption device. With the movable portion, the hydrogen tank is moved among a hydrogen supply stop position, the hydrogen supply standby position, and the hydrogen supply start position.

The movable portion may include a tank insertion hole.

The tank insertion hole is a space in which the hydrogen tank is accommodated. The tank insertion hole may include an opening through which the hydrogen tank can be taken in or out, and may be a space surrounded by an inner wall.

The movable portion may include an engagement recessed portion (a positioning hole) that can be engaged with the lock portion.

The engagement recessed portion may be provided on the lower surface side of the movable portion. As long as the engagement recessed portion is configured such that the lock pin is engageable and separable, the specific form of the engagement recessed portion is not particularly limited, and the engagement recessed portion may be a dent or have a groove shape.

The width (the size in a direction in which the movable portion moves) of the engagement recessed portion may be larger than the width of the lock pin. In this manner, even in a state in which the lock pin projects to enter the inner side of the engagement recessed portion, the movable portion can move within a range of the width of the engagement recessed portion.

The movable portion may be a movable placement stage.

The movable placement stage is a member on which the hydrogen tank can be placed on the upper surface side, and is a member in which, when the movable placement stage includes a tank insertion hole on the upper surface side, the hydrogen tank can be inserted and fixed to the tank insertion hole. The movable placement stage means a stage having a movable property capable of moving, in a state of carrying the hydrogen tank, in a direction in which the first connection portion of the hydrogen tank is connected to the second connection portion of the hydrogen consumption device and a direction in which the first connection portion of the hydrogen tank is detached from the second connection portion of the hydrogen consumption device. Means for performing the movement is not particularly limited, and examples of the means include a combination of a rail and a wheel.

The movable placement stage may be a base stage (a tank placement stage).

The hydrogen consumption device may include hydrogen consumption equipment.

Examples of the hydrogen consumption equipment include a fuel cell, a hydrogen engine, and a combustion unit such as a hydrogen burner.

The hydrogen consumption device may include a supply flow path (a hydrogen pipe).

The supply flow path is configured of a pipe that is a path that guides the hydrogen from the hydrogen tank to the hydrogen consumption equipment. The supply flow paths extending from the respective hydrogen tanks may be joined to form one supply flow path to be connected to the hydrogen consumption equipment.

The hydrogen consumption device may include an injection.

The injection is disposed in a supply flow path between the second connection portion and the hydrogen consumption equipment to control supply of the hydrogen to the hydrogen consumption equipment. Examples of the injection include a check valve and a flow regulating valve.

The hydrogen consumption device may include a pressure gauge.

The pressure gauge may be provided on each supply flow path so as to correspond to an inner pressure of each hydrogen tank, and may measure a flow path inner pressure (a pressure in the pipe) of each supply flow path.

The pressure gauge is configured to be capable of transmitting obtained pressure value data to the control device.

In the hydrogen consumption device, the inserting and fixing of the hydrogen tank, the attaching of the hydrogen tank, the detaching of the hydrogen tank, and the like are performed.

The inserting and fixing (setting) of the hydrogen tank means operation of disposing the hydrogen tank at a position (the hydrogen supply stop position) from which the attaching of the hydrogen tank is started. Specifically, the inserting and fixing (setting) of the hydrogen tank may be operation performed by, for example, manual work of human from the outside of the hydrogen supply system to insert and fix the hydrogen tank to the hydrogen insertion hole of the movable portion of the attaching-detaching unit of the attaching-detaching mechanism of the hydrogen consumption device.

The attaching of the hydrogen tank means operation of connecting the hydrogen tank and the hydrogen consumption device in a state in which the hydrogen tank is allowed to supply the hydrogen to the hydrogen consumption device. Specifically, the attaching of the hydrogen tank means operation of moving the hydrogen tank from the hydrogen supply stop position to a position (the hydrogen supply standby position) at which accurate positioning is started in order to connect the first connection portion of the hydrogen tank and the second connection portion of the hydrogen consumption device, and further moving the hydrogen tank from the hydrogen supply standby position to a position (the hydrogen supply start position) at which the first connection portion of the hydrogen tank and the second connection portion of the hydrogen consumption device are connected, thereby connecting the pair of connection portions to each other.

The detaching of the hydrogen tank means operation of disconnecting the first connection portion of the hydrogen tank and the second connection portion of the hydrogen consumption device, and moving the hydrogen tank from the hydrogen supply start position to the hydrogen supply standby position and operation of moving the hydrogen tank from the hydrogen supply standby position to the hydrogen supply stop position in order to make it possible to take out the hydrogen tank.

The hydrogen supply stop position is a position from which the attaching of the hydrogen tank to the hydrogen consumption device is started, and a position at which the hydrogen tank can be taken out. Specifically, the hydrogen supply stop position is a position at which, by, for example, manual work of human from the outside of the hydrogen supply system, the hydrogen tank is inserted and fixed to the hydrogen insertion hole of the movable portion of the attaching-detaching unit of the attaching-detaching mechanism of the hydrogen consumption device. The hydrogen supply stop position may be a position separated from the fitting portion of the attaching-detaching unit than the hydrogen supply standby position. Specifically, the hydrogen supply stop position may be a position at which the first connection portion of the hydrogen tank and the second connection portion of the hydrogen consumption device are not connected and the movable portion and the fitting portion are not in contact, and thus the lock by the lock pin cannot be performed. The position at which the lock by the lock pin cannot be performed means a position at which, in a movable direction of the movable portion of the attaching-detaching unit, a distance from the push rod to the engagement recessed portion of the movable portion is larger than a distance from the push rod to the lock pin.

It is sufficient that the hydrogen supply standby position is a position at which the hydrogen tank and the hydrogen consumption device are not connected in the state in which the hydrogen tank is allowed to supply the hydrogen to the hydrogen consumption device and the hydrogen tank stands by for supply of the hydrogen. The hydrogen supply standby position may be a position at which the first connection portion of the hydrogen tank and the second connection portion of the hydrogen consumption device are not connected, for example, a position at which, through control of the motor, accurate positioning for connecting the first connection portion of the hydrogen tank and the second connection portion of the hydrogen consumption device is started, specifically, a position at which the first connection portion of the hydrogen tank and the second connection portion of the hydrogen consumption device are not connected and the movable portion and the fitting portion are in contact, and thus the lock by the lock pin can be performed.

It is sufficient that the hydrogen supply start position is a position at which the hydrogen tank and the hydrogen consumption device are connected in the state in which the hydrogen tank is allowed to supply the hydrogen to the hydrogen consumption device. Specifically, the hydrogen supply start position may be a position at which, through control of the motor, the first connection portion of the hydrogen tank and the second connection portion of the hydrogen consumption device are connected.

### Control Device

The control device is a device that performs control or the like in order to connect the hydrogen tank to the hydrogen consumption device. The control device is a device that performs control or the like in order to connect the first connection portion (the on-off valve or the like) of the hydrogen tank to the second connection portion (the push rod or the like) of the hydrogen consumption device. The control device may be configured to be capable of communicating with the lock pin, the stepping motor, various sensors, the injection, and the pressure gauge.

The control device may include a central processing unit (CPU) that is a processor and performs computation, a random access memory (RAM) that functions as a work area, a read-only memory (ROM) that functions as a recording medium, a receiver that is an interface that receives information regardless of wired or wireless into the control device, and a transmitter that is an interface that transmits information regardless of wired or wireless to the outside from the control device.

Thus, the control device may be configured so that the receiver is connected to the various sensors and the pressure gauge to receive information, and the transmitter is connected to the lock pin, the stepping motor, and the injection to transmit signals for actuation of those members.

The control device may be an electronic control unit (ECU) or the like.

The control device disposes, based on the temperature of each of the motors, the hydrogen tank to the hydrogen supply start position at which the hydrogen tank and the hydrogen consumption device are connected in the state in which the hydrogen tank is allowed to supply the hydrogen to the hydrogen consumption device, or disposes the hydrogen tank to the hydrogen supply standby position at which the hydrogen tank and the hydrogen consumption device are not connected in the state in which the hydrogen tank is allowed to supply the hydrogen to the hydrogen consumption device and the hydrogen tank stands by for supply of the hydrogen.

Before the hydrogen tank is attached to the attaching-detaching unit of the hydrogen consumption device, the control device first inserts and fixes the hydrogen tank to the hydrogen supply stop position. At the time of attaching the hydrogen tank to the attaching-detaching unit of the hydrogen consumption device, the control device moves the hydrogen tank from the hydrogen supply stop position to the hydrogen supply standby position, and further moves the hydrogen tank from the hydrogen supply standby position to the hydrogen supply start position, to thereby connect the hydrogen tank to the hydrogen consumption device. At the time of detaching the hydrogen tank from the attaching-detaching unit of the hydrogen consumption device, the control device moves the hydrogen tank from the hydrogen supply start position to the hydrogen supply standby position, and disconnects the hydrogen tank and the hydrogen consumption device.

The temperature of the motor may be detected by a motor temperature sensor. The temperature of the motor may be constantly monitored.

When n (n is an integer of 2 or more) hydrogen tanks are disposed at the hydrogen supply start position, the control device determines whether or not the temperature of each of the n motors is equal to or higher than a first threshold value. When the temperature of each of m (1≤m≤n−1) motors out of the n motors is equal to or higher than the first threshold value, the control device moves at least the hydrogen tank that is controlled in the attaching and detaching by the motor having the highest temperature from the hydrogen supply start position to the hydrogen supply standby position, and stops the control of the motor having the highest temperature.

When n is an integer of 3 or more and m satisfies 2≤m≤n−1, the control device may move the m hydrogen tanks that are controlled in the attaching and detaching by the m motors from the hydrogen supply start position to the hydrogen supply standby position, and may stop the control of the m motors.

When m=0 is satisfied, the control device continues the control of all of the motors.

When m=n is satisfied, the control device moves all of the hydrogen tanks from the hydrogen supply start position to the hydrogen supply standby position, and stops the control of all of the motors.

The control device determines whether or not the temperature of the stopped motor is equal to or lower than the second threshold value. When the temperature of the stopped motor is equal to or lower than the second threshold value, the control device may start the control of the stopped motor, and may move the hydrogen tank that is controlled in the attaching and detaching by the motor for which the control has been started from the hydrogen supply standby position to the hydrogen supply start position.

When the temperature of the stopped motor exceeds the second threshold value, the control device may keep the stopped motor in a stopped state, and may determine again whether or not the temperature of the stopped motor is equal to or lower than the second threshold value.

It is sufficient that the second threshold value is a temperature lower than the first threshold value, and the second threshold value may be set as appropriate depending on the performance of the motor.

The control device performs attaching-detaching control of the hydrogen tank with respect to the hydrogen consumption device.

The attaching-detaching control includes detaching control and attaching control.

The detaching control includes a disconnection step and a separation step.

The disconnection step is a step of moving the hydrogen tank from the hydrogen supply start position to the hydrogen supply standby position with respect to the hydrogen consumption device. With the disconnection step, the hydrogen consumption device and the hydrogen tank are disconnected.

The separation step is a step of moving the hydrogen tank from the hydrogen supply standby position to the hydrogen supply stop position with respect to the hydrogen consumption device. With the separation step, the hydrogen tank is allowed to be taken out from the hydrogen consumption device.

The attaching control includes an approaching step and a connection step.

The approaching step is a step of moving the hydrogen tank from the hydrogen supply stop position to the hydrogen supply standby position with respect to the hydrogen consumption device. With the approaching step, the hydrogen tank is disposed at a position at which the hydrogen tank stands by for the supply of the hydrogen to the hydrogen consumption device.

The connection step is a step of moving the hydrogen tank from the hydrogen supply standby position to the hydrogen supply start position with respect to the hydrogen consumption device. With the connection step, the hydrogen tank and the hydrogen consumption device are connected in the state in which the hydrogen tank is allowed to supply the hydrogen to the hydrogen consumption device.

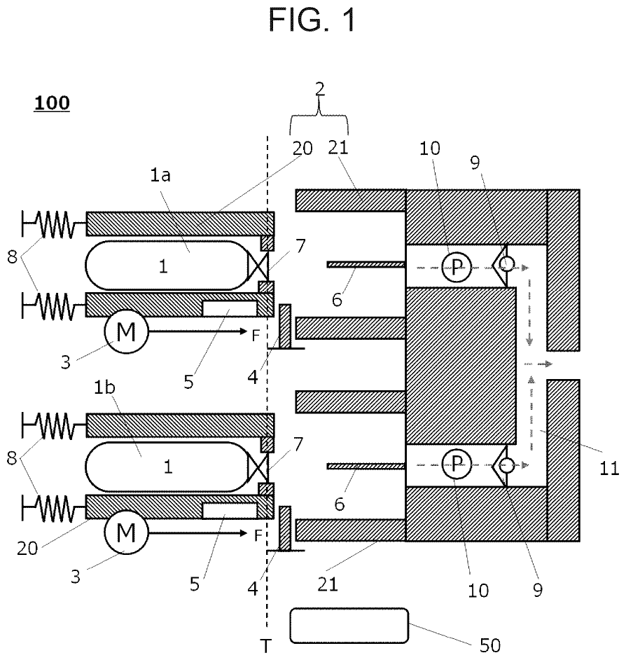

FIG. 1 is a view illustrating an example of a configuration of the hydrogen supply system of the present disclosure.

A hydrogen supply system 100 illustrated in FIG. 1 includes a hydrogen tank 1 (an upper tank 1a and a lower tank 1b), an attaching-detaching unit 2, a stepping motor 3, a lock pin 4, a positioning hole 5, a push rod 6, an on-off valve 7, a spring 8, a check valve 9, a pressure sensor 10, a supply flow path 11, a movable portion 20, a fitting portion 21, and a control device 50. F indicates the positioning direction, and the arrow of the chain line indicates the flow of hydrogen. The hydrogen passes through the supply flow path 11 to be supplied to the hydrogen consumption equipment (not shown).

As illustrated in FIG. 1, the hydrogen tank 1 is disposed at a hydrogen supply stop position T in a state in which the on-off valve 7 of the hydrogen tank 1 and the push rod 6 in the fitting portion 21 of the attaching-detaching unit 2 are not connected and the movable portion 20 and the fitting portion 21 are not in contact, and thus the lock by the lock pin 4 at the positioning hole 5 of the movable portion 20 is not performed.

The hydrogen tank 1 disposed at the hydrogen supply stop position T is in a state in which, at the position from which fitting of the hydrogen tank 1 to the fitting portion 21 of the attaching-detaching unit 2 (attaching to the attaching-detaching unit 2) is started, the hydrogen tank 1 is inserted and fixed to the tank insertion hole of the movable portion 20 of the attaching-detaching unit 2.

The hydrogen supply stop position T is a position at which, in the movable direction of the movable portion 20 of the attaching-detaching unit 2, the distance from the push rod 6 to the positioning hole 5 of the movable portion 20 is larger than the distance from the push rod 6 to the lock pin 4.

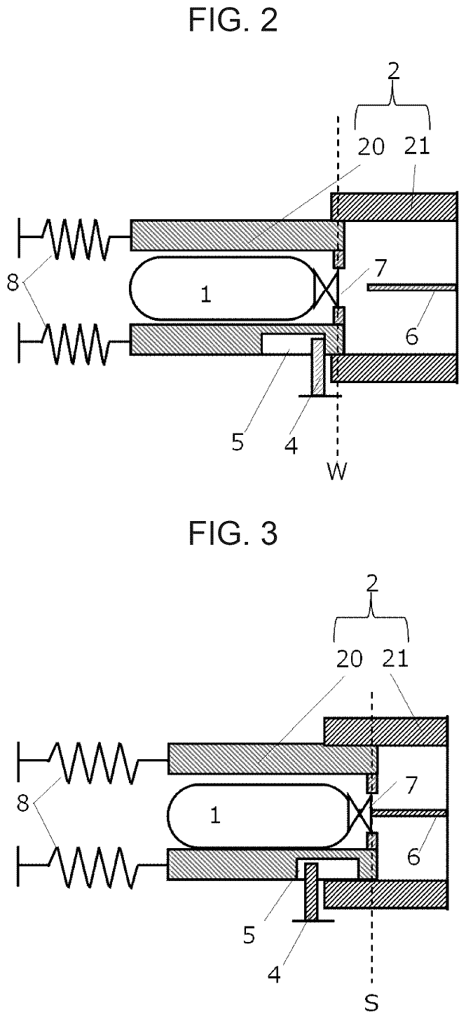

FIG. 2 is a schematic view illustrating an example of a state in which the hydrogen tank is disposed at a hydrogen supply standby position W.

As illustrated in FIG. 2, the hydrogen tank 1 is disposed at the hydrogen supply standby position W in a state in which the on-off valve 7 of the hydrogen tank 1 and the push rod 6 in the fitting portion 21 of the attaching-detaching unit 2 are not connected and the movable portion 20 and the fitting portion 21 are in contact, and thus the lock pin 4 abuts against the positioning hole 5 of the movable portion 20 due to the spring force of the spring 8. The on-off valve 7 of the hydrogen tank 1 is not connected to the push rod 6 in the fitting portion 21 of the attaching-detaching unit 2, and the on-off valve 7 is in a closed state.

The hydrogen tank 1 disposed at the hydrogen supply standby position W is in a state of not being fitted into the fitting portion 21 of the attaching-detaching unit 2 (not being attached to the attaching-detaching unit 2), and is in a state of being detached from the attaching-detaching unit 2.

FIG. 3 is a schematic view illustrating an example of a state in which the hydrogen tank is disposed at a hydrogen supply start position S.

As illustrated in FIG. 3, the hydrogen tank 1 is disposed at the hydrogen supply start position S in a state in which the on-off valve 7 of the hydrogen tank 1 and the push rod 6 in the fitting portion 21 of the attaching-detaching unit 2 are connected and the lock by the lock pin 4 at the positioning hole 5 of the movable portion 20 is performed. The on-off valve 7 of the hydrogen tank 1 is connected to the push rod 6 in the fitting portion 21 of the attaching-detaching unit 2, and the on-off valve 7 is in an open state.

The hydrogen tank 1 disposed at the hydrogen supply start position S is fitted to the fitting portion 21 of the attaching-detaching unit 2, and is in a state of being attached to the attaching-detaching unit 2.

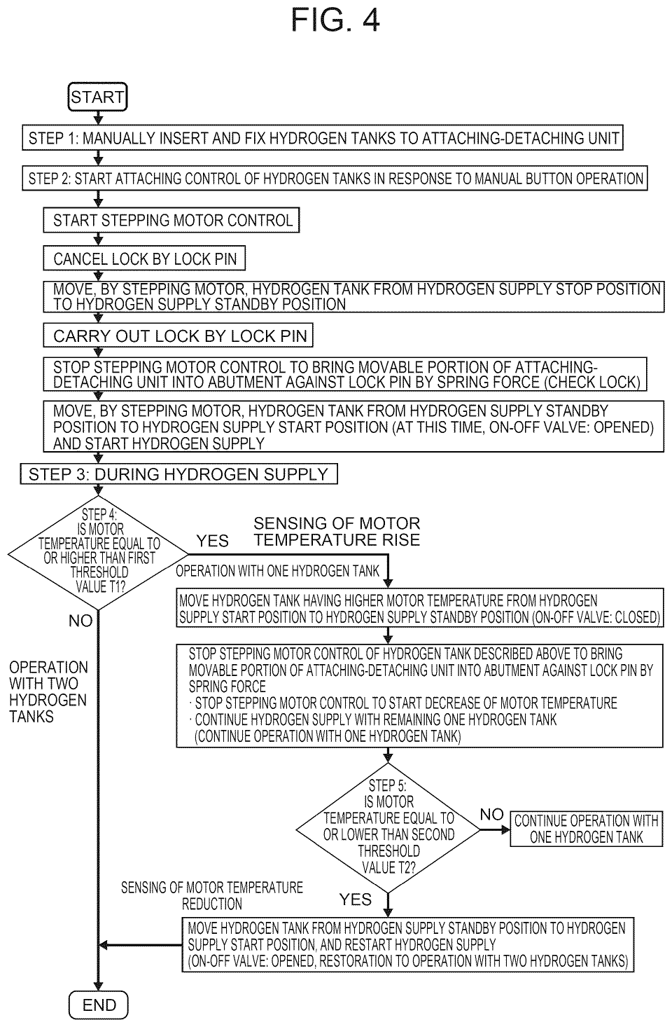

FIG. 4 is a flowchart illustrating an example of connection control of the hydrogen tanks. The flowchart illustrated in FIG. 4 represents an example of control in the case of the hydrogen supply system including two hydrogen tanks illustrated in FIG. 1.
STEP 1: Manually insert and fix two hydrogen tanks to attaching-detaching unit: dcm1=dstp, dcm2=dstp
STEP 2: Start attaching control of two hydrogen tanks in response to manual button operation:
xh2sply=ON
   Start stepping motor control:
xmot1=ON, xmot2=ON
   Cancel lock by lock pin:
xlck1=ON, xlck2=ON
   Move, by stepping motor, hydrogen tank from hydrogen supply stop position to hydrogen supply standby position:
dcm1=dstb, dcm2=dstb
   Carry out lock by lock pin:
xlck1=OFF, xlck2=OFF
   Stop stepping motor control to bring movable portion of attaching-detaching unit into abutment against lock pin by spring force (check lock):
xmot1=OFF, xmot2=OFF
   Move, by stepping motor, hydrogen tank from hydrogen supply standby position to hydrogen supply start position (at this time, the on-off valve and the push rod are in contact. The on-off valve is opened by the pressing force applied from the push rod to the on-off valve.) and start supply of hydrogen:
xmot1=ON, xmot2=ON, dcm1=dsply, dcm2=dsply
STEP 3: During hydrogen supply
STEP 4: When motor temperature is less than first threshold value T1 during hydrogen supply, carry out normal operation (continue operation with two hydrogen tanks). When motor temperature is equal to or higher than first threshold value T1 during hydrogen supply, carry out restriction operation. When motor temperature of connected hydrogen tank is equal to or higher than first threshold value T1 during operation with one hydrogen tank, quit continuation of operation. Stop diagnostics.
   Move hydrogen tank having higher motor temperature from hydrogen supply start position to hydrogen supply standby position (on-off valve: closed):
dcm1=dstb (in this example, move upper tank)
   Stop stepping motor control of upper tank described above to bring movable portion of attaching-detaching unit into abutment against lock pin by spring force:
xmot1=OFF
   Stop stepping motor control to start decrease of motor temperature
   Continue hydrogen supply with remaining one lower tank (continue operation with one hydrogen tank)
STEP 5: When motor temperature of upper tank moved to hydrogen supply standby position exceeds second threshold value T2, continue operation with one hydrogen tank. When motor temperature of upper tank moved to hydrogen supply standby position is equal to or lower than second threshold value T2, carry out restoring operation.
   Move upper tank from hydrogen supply standby position to hydrogen supply start position, and restart hydrogen supply (on-off valve: opened, restoration to operation with two hydrogen tanks):
xmot1=ON, dcm1=dsply
dcm1: hydrogen tank position (upper tank)
dcm2: hydrogen tank position (lower tank)
dstp: hydrogen supply stop position
dstb: hydrogen supply standby position
dsply: hydrogen supply start position
T1: motor temperature rise sensing threshold value (first threshold value)
T2: motor temperature reduction sensing threshold value (second threshold value)
xh2sply: hydrogen tank attaching-detaching control instruction
xmot1: motor control state (upper tank) ON: control start, OFF: control stop
xmot2: motor control state (lower tank) ON: control start, OFF: control stop
xlck1: lock pin state (upper tank) ON: unlock, OFF: carry out lock
xlck2: lock pin state (lower tank) ON: unlock, OFF: carry out lock

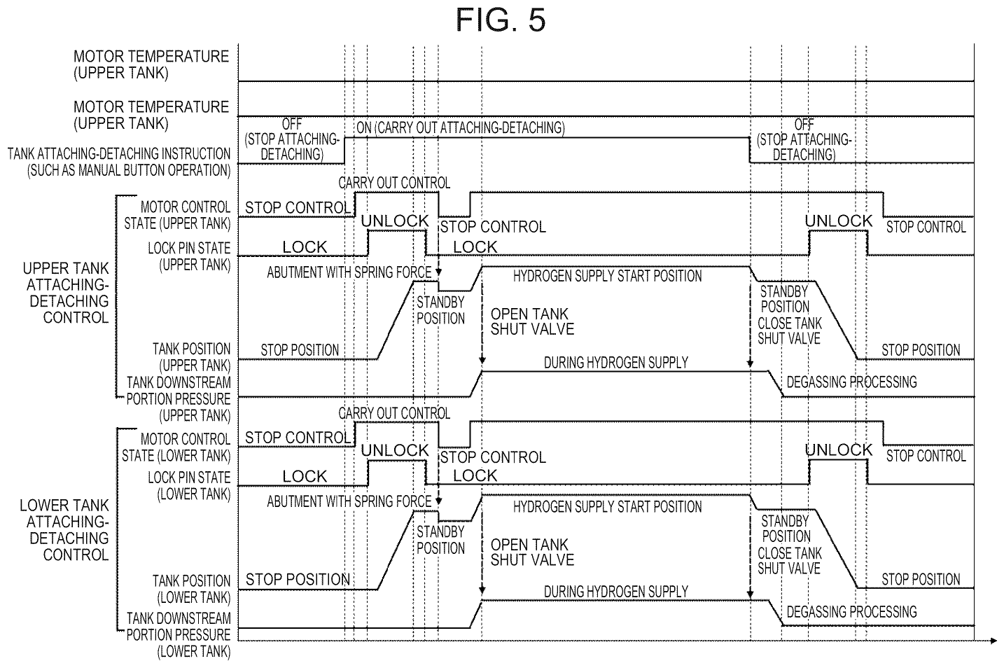

FIG. 5 is a view illustrating an example of a time chart in a case where the normal operation is carried out in STEP 4 in the connection control of the hydrogen tanks illustrated in FIG. 4.

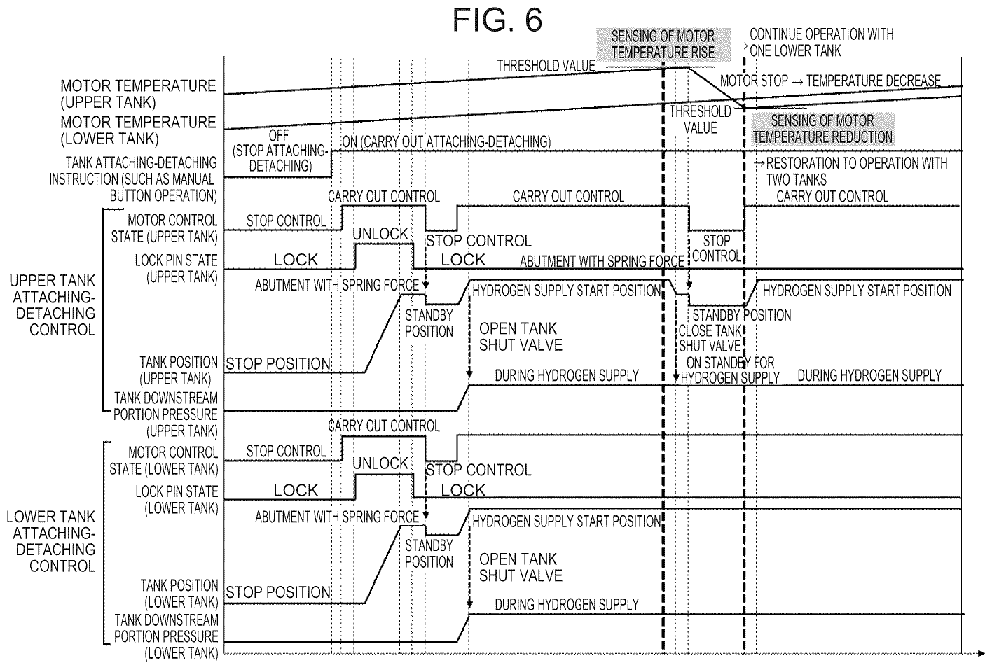

FIG. 6 is a view illustrating an example of a time chart in a case where the restriction operation is carried out in STEP 4 in the connection control of the hydrogen tanks illustrated in FIG. 4.

In the present disclosure, in a case where the hydrogen tanks are disposed at the hydrogen supply start position (connection position), while the operation of the hydrogen consumption device is continued (in particular, while the operation is continued under a high-temperature environment), when the temperature of the motor for attaching and detaching the tank is equal to or higher than the first threshold value, the hydrogen tank is moved from the hydrogen supply start position to the hydrogen supply standby position (standby position) so that the on-off valve of the hydrogen tank is closed and the motor control of the hydrogen tank is stopped, thereby decreasing the temperature of the motor. When the temperature of the motor is equal to or lower than the second threshold value (after the decrease in temperature is completed), the motor control is carried out so that the hydrogen tank is moved from the standby position to the connection position, and the on-off valve of the hydrogen tank is opened. With those controls, the supply of the hydrogen can be continued, and the performance under the high-temperature environment (the time for which the continuous operation is allowed, the maximum temperature) is increased, resulting in improved convenience.

What is claimed is:

1. A hydrogen supply system comprising:
a plurality of hydrogen tanks that is attachable and detachable;
a hydrogen consumption device that consumes hydrogen of the hydrogen tanks; and
a control device, wherein:
the hydrogen consumption device includes an attaching-detaching mechanism including a plurality of motors that controls attaching and detaching of the hydrogen tanks with respect to the hydrogen consumption device, the motors corresponding to the attaching and detaching of the respective hydrogen tanks; and
the control device disposes, based on a temperature of each of the motors, a hydrogen tank of the hydrogen tanks to a hydrogen supply start position at which the hydrogen tank and the hydrogen consumption device are connected in a state in which the hydrogen tank is allowed to supply hydrogen to the hydrogen consumption device, or disposes the hydrogen tank to a hydrogen supply standby position at which the hydrogen tank and the hydrogen consumption device are not connected in the state in which the hydrogen tank is allowed to supply the hydrogen to the hydrogen consumption device and the hydrogen tank stands by for supply of the hydrogen.

2. The hydrogen supply system according to claim 1, wherein, when the hydrogen tanks are disposed at the hydrogen supply start position;
the control device determines whether or not the temperature of each of the motors is equal to or higher than a first threshold value; and
when the temperature of at least one motor out of the motors is equal to or higher than the first threshold value, the control device moves at least a hydrogen tank that is controlled in the attaching and detaching by a motor having a highest temperature from the hydrogen supply start position to the hydrogen supply standby position, and stops control of the motor having the highest temperature.

3. The hydrogen supply system according to claim 2, wherein:
the control device determines whether or not the temperature of the stopped motor is equal to or lower than a second threshold value; and
when the temperature of the stopped motor is equal to or lower than the second threshold value, the control device starts control of the stopped motor, and moves the hydrogen tank that is controlled in the attaching and detaching by the motor for which the control has been started from the hydrogen supply standby position to the hydrogen supply start position.

4. The hydrogen supply system according to claim 1, wherein:
the hydrogen tank includes a first connection portion;
the attaching-detaching mechanism includes an attaching-detaching unit;
the attaching-detaching unit includes a second connection portion;
at the hydrogen supply start position, the first connection portion of the hydrogen tank and the second connection portion of the attaching-detaching unit are connected; and
at the hydrogen supply standby position, the first connection portion of the hydrogen tank and the second connection portion of the attaching-detaching unit are not connected.

5. The hydrogen supply system according to claim 4, wherein:
the first connection portion is an on-off valve; and
the second connection portion is a push rod.
